(19) United States
(12) Patent Application Publication
(10) Pub. No.: US 2008/0259126 A1
(43) Pub. Date: Oct. 23, 2008

(54) PRINTING CONTROL

(75) Inventor: David R. Otis, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company LP

(21) Appl. No.: 11/739,070

(22) Filed: Apr. 23, 2007

(51) Int. Cl. B41J 2/04

(52) U.S. Cl. 347/54

(57) ABSTRACT

Various methods and apparatus relating to the control of printing by a print head based upon a captured image of an array of printed marks are disclosed.

### CROSS-REFERENCE TO RELATED PATENT APPLICATIONS

The present application is related to co-pending U.S. patent application Ser. No. ______ file on the same day here with by and entitled DROP-ON-DEMAND MANUFACTURING OF DIAGNOSTIC TEST STRIPS and co-pending U.S. patent application Ser. No. ______ file on the same day here with by ______ and entitled SENSING OF FLUID EJECTED BY DROP-ON-DEMAND NOZZLES, the full disclosures of which are hereby incorporated by reference.

### BACKGROUND

Drop-on-demand ink jet printers may experience shifts or changes in performance over the course of their life or in response to environmental or usage factors. Such changes may impact consistency and quality of print performance.

### BRIEF DESCRIPTION OF THE DRAWINGS

FIG. 1 is a schematic illustration of a printer according to an example embodiment. FIG. 2 is a sectional view schematically illustrating the printer of FIG. 1 according to an example embodiment.

FIG. 3 is a flow diagram illustrating an example method of controlling printing according to an example embodiment.

FIG. 4 is a top plan view of a pattern of printed marks according to an example embodiment.

FIG. 5 is a top plan view of another pattern of printed marks according to an example embodiment.

FIG. 6 is a top perspective view schematically illustrating positioning of a vision system and pen of the printer of FIG. 1 over a printed mark of the pattern of FIG. 5 according to an example embodiment.

FIG. 7 is aside elevational view schematically illustrating printing of marks at a first spacing according to an example embodiment.

FIG. 8 is a side of elevational view schematically illustrating printing of marks at a second spacing according to an example embodiment.

FIG. 9 is a side elevation view schematically illustrating printing a coating upon a first surface at the first spacing according to an example embodiment.

FIG. 10 is a side elevation view schematically illustrating printing a second coating upon a second surface at the second spacing according to an example embodiment.

### DETAILED DESCRIPTION OF THE EXAMPLE EMBODIMENTS

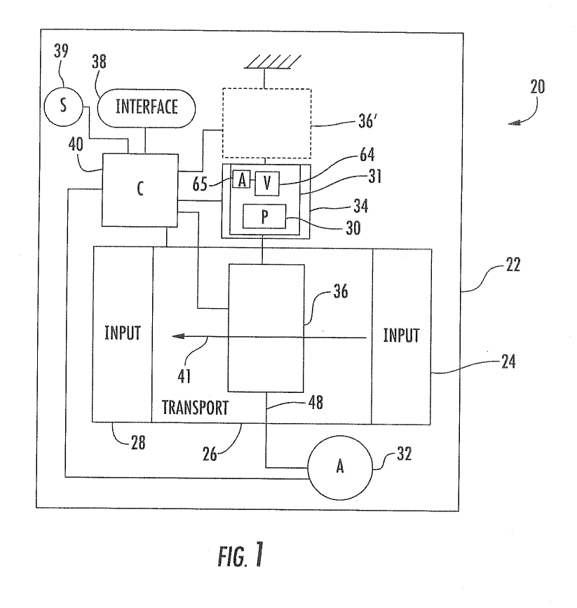

FIG. 1 schematically illustrates printer 20 according to an example embodiment. Printer 20 comprises a self-contained unit configured to deposit fluid onto one or more target media using drop-on-demand inkjet nozzles. Such target media may comprise strips or sheets of material or three-dimensional objects. As will be described hereafter, printer 20 is configured to print or coat fluids upon such target media with enhanced print quality and consistency.

As shown by FIG. 1, printer 20 includes housing 22, input 24, transport 26, output 28, drop-on-demand pen 30, carriage 31, actuator 32, service station 34, sensing system 36, interface 38, sensor 39 and controller 40. Housing 22 comprises one or more structures which serve as a framework, support and enclosure for containing the remaining components of printer 20 as a self-supported and self-contained unit. As a result, each of the noted components of printer 20 may be stored, shipped and utilized without substantial additional assembly. In addition, many of the components may employ a common power connection and may be arranged in a compact architecture. Although housing 22 is schematically illustrated as a box, housing 22 may have a variety of different sizes, shapes and configurations.

Input 24 comprises one or more structures supported by housing 22 configured to store and deliver target media to transport 26. In those embodiments in which the target media comprises sheets of one or more materials, input 24 may comprise a tray or bin. In other embodiments where target media has other geometries, input 24 may have other configurations such as a die and funnel for singulating individual target media and delivering such singulated target media to transport 26.

Transport 26 comprises a mechanism configured to receive target media from input 24, to deliver or move the target media relative to pen 30 and to subsequently move the printed upon target media to output 28. In one embodiment wherein the target media comprises sheets of material, transport 26 may comprise a series of rollers, belts, movable trays, a drum, robotic arms and the like. In other embodiments, transport 26 may comprise other mechanisms configured to grasp or hold the target media as a target media is moved with respect to pen 30. In particular embodiments in which the target media is manually positioned with respect to pen 30, transport 26 as well as input 24 and output 28 may be omitted.

Output 28 comprises one or more structures configured to receive printed material from transport 26. In one embodiment, output 28 may be configured to provide a person with access to media which has been printed upon. In another embodiment, output 28 may be configured to be connected to another device or transport for further moving the printed upon-target-media to another mechanism for further interaction or treatment. In one embodiment, output 28 may comprise a tray or bin.

Drop-on-demand inkjet pen 30 comprises one or more print heads having a plurality of nozzles 44 (schematically illustrated in FIG. 2) through which fluid is ejected. According to one embodiment, drop-on-demand ink jet pen 30 may comprise a thermoresistive print head. In another embodiment, pen 30 may comprise a piezo resistive print head. According to one embodiment, pen 30 may be part of a cartridge which also stores the fluid to be dispensed. In another embodiment, pen 30 may be supplied with fluid by an off-axis ink supply. Examples of fluid that may be dispensed include, but are not limited to, inks, reagents, solutions including electrically conductive solutes, solutions including electrically semi-conductive solutes, medicinal fluid coatings, polymeric fluid coatings and the like. Examples of target media upon which the fluids may be deposited include, but are not limited to, diagnostic strips, sheets of media, stents, electronic devices, circuit boards, flexible circuits and various other two-dimensional and three-dimensional objects.

Carriage 31 comprises a structure movably supporting pen 30. In one embodiment, carriage 31 comprises a structure configured to slide or move along a guide 48, such as a rod, bar or rack gear. In one embodiment, carriage 31 is configured to removably receive pen 30. In other embodiments, carriage 31 may have other configurations.

Actuator 32 comprises a mechanism operably coupled to carriage 31 while being configured to move carriage 31 and pen 30 between a printing position in which pen 30 is located opposite to a target media position by transport 26, a second position in which pen 30 is located opposite to service station 34 for servicing of pen 30 (shown in FIG. 1) and a third position (shown in FIG. 2) in which pen 30 is positioned opposite to sensing system 36 for determining changes in the performance of pen 30. Actuator 32 may comprise a motor (such as a stepper or servo motor) operably coupled to pen 30 by a belt, drive train or transmission whose motion may be controlled by use of an encoder strip or other positional control mechanism. In other embodiments, actuator 32 may comprise an electric solenoid, or hydraulic or pneumatic cylinder assembly.

Service station 34 comprises an arrangement of components configured to service pen 30. Examples of servicing operations include, but are not limited to, spitting and wiping. For example, in one embodiment, service station 34 may include a spittoon into which pen 30 may spit or eject fluid to clear nozzles 44. Service station 34 may additionally include a blade or fabric belt configured to contact and wipe nozzles 44 to remove accumulated debris about nozzles 44. In other embodiments, service station 34 may include a primer (which applied either suction or positive pressure to the nozzles) or be omitted.

Sensing system 36 comprises a system or arrangement of components configured to sense one or more characteristics of nozzles 44 and the fluid ejected by nozzles 44 of pen 30. The sensed characteristics are communicated to controller 40, enabling controller 40 to adjust operating parameters of pen 30 to accommodate changes in characteristics of nozzles 44 and the fluid ejected by nozzles 44 over time. In one embodiment, system 36 senses the location of fluid ejected by nozzles 44 to identify non-existent firing, misdirected firing, firing of incorrect quantity and fluid composition discrepancies. In one embodiment, sensing system 36 is further configured or alternatively configured to the sense characteristics of the ejected fluid, facilitating a determination of a volume or mass of fluid ejected by a single nozzle 44 or a selected group of nozzles 44.

Based upon such identified errors or characteristics, controller 40 adjusts or recalibrates stored ejection control parameters for subsequent printing. For example, upon determining that one or more nozzles 44 have directionality or trajectory errors (i.e., an effective jet axis being non-orthogonal to an orifice of a nozzle), controller 40 may adjust the timing in which the one or more nozzles are fired by adjusting the time at which the control signals are transmitted to pen 30 or the time at which the control signals direct the particular nozzle to eject fluid. In addition, or alternatively, controller 40 may adjust the positioning of the target media relative to the nozzles to more accurately deposit the fluid (and its solute) in the accurate position. Upon determining that one or more nozzles 44 are ejecting a lesser or greater amount or volume of fluid than desired in response to a given firing energy controller 40 may adjust firing energies applied to the selected nozzle 44 or group of nozzles 44. For purposes of this disclosure, the term “firing energy” includes at least one aspect of firing intensity, such as number of pulses applied to a given nozzle, pulse voltage, pulse time, pulse pulse frequency, and the number of nozzles that are pulsed, and the temperature of the nozzle array (which may be controlled by resistors on the printhead). As a result, sensing system 36 provides printer 20 with greater control over the location at which drops of fluid are deposited upon a target media and greater control over the actual amount of fluid deposited at the location by nozzles 44.

As shown by FIG. 1, in the example embodiment illustrated, sensing system 36 is located between input 24 and output 28 along a target media path 41 schematically illustrated by arrow 41. In one embodiment, sensing system 36 is located below transport 26 and has operating components that move between a lowered inset or withdrawn position below transport 26 and a raised or elevated position that may be coextensive with or substantially level with transport 26 or that may project above transport 26. In other embodiments, as indicated in broken lines, printer 20 may alternatively include sensing system 36′ located outside of a perimeter of transport 26 and outside of media path 41. For example, as shown by FIG. 1, sensing system 36′ may alternatively be located proximate to service station 34.

FIG. 2 is a sectional view schematically illustrating sensing system 36 in more detail. As shown by FIG. 2, sensing system 36 includes enclosure 50, ionic gas source 52, cover 54, actuator 56, substrate 58, actuator 60, light source 62, vision system 64, actuator 65 and substrate servicing system 66. Enclosure 50 comprises a chamber or housing extending at least partially about substrate 58. Enclosure 50 assists in maintaining substrate 58 in a clean uncontaminated state. Enclosure 50 further enables the environment of substrate 58 to be better controlled with respect to humidity and temperature. Although illustrated as generally rectangular, enclosure 50 may have a variety of sizes, shapes and configurations. In other embodiments, enclosure 50 may be omitted.

Ionized gas source 52 is configured to supply an ionized gas to at least substrate 58 and pen 30. Source 52 suppresses electrostatic effects that may affect fluid droplet trajectory onto substrate 58. In the example illustrated, source 52 includes pump 68 and filter 70. Pump 68 supplies dry nitrogen gas through a filter 70, a HEPA filter, to an interior of enclosure 50. In the embodiment illustrated, substrate 58 and pen 30 are further grounded to further suppress such electrostatic effects. In other embodiments, source 52 may be omitted.

Cover 54 comprises a panel, door or other structure movable between a covering position (shown in FIG. 2) in which cover 54 extends across substrate 58 between the substrate 58 and carriage 3 1, and a retracted position. In the covering position, cover 54 cooperates with enclosure 50 to maintain a clean environment about substrate 58 and further provides a surface upon which target media being printed upon by pen 30 may be supported.

Actuator 56 comprises a mechanism configured to actuate or move cover 54 between a covering position and the retracted position. In one embodiment, actuator 56 may comprise a motor operably coupled to cover 54. For example, actuator 56 may be operably coupled to a pinion gear in engagement with a rack gear (not shown) that is coupled to cover 54. In other embodiments, electric solenoids or hydraulic or pneumatic cylinder assemblies may alternatively be used to move cover 54. In some embodiments where target media being printed upon is supported by substrate 58 during printing or where sensing system 36 is located outside of media path 41, such as with sensing system 36′, cover 54 and actuator 56 may be omitted.

Substrate 58 comprises a substantially planar tray, stage, panel or platform movably supported for movement between a retracted or lowered inactive position in which substrate 58 extends below cover 54 within enclosure 50 and a raised active position in which a top 71 of substrate 58 is coextensive with a top of cover 54 or in which a top 71 of substrate 58 is elevated above a top of cover 54. Because substrate 58 is movable to and inactive position within enclosure 50, the maintenance of substrate 58 in a clean state is enhanced. Moreover, because substrate 58 is movable so as to locate top 71 in close proximity or at substantially the same spacing with respect to nozzles 44 of pen 30 as the subsequent actual spacing between nozzles 44 of pen 30 and the target media being printed upon, results from sensing system 36 may be more reliable and adjustments based on such sensed values may result in enhanced control of the amount and applied location of fluid being ejected by nozzles 44. As will be described hereafter with respect to FIGS. 7-10, because substrate 58 is movable between a plurality of positions with respect to nozzles 44, sensing system 36 may capture images of ejected fluid at multiple spacings with respect to nozzles 44 corresponding to multiple spacings between nozzle 44 and target surfaces to be printed upon. Consequently, different print control adjustments may be made to accommodate three dimensional target objects or target media having multiple surfaces differently spaced from nozzles 44 during printing.

In the example embodiment illustrated, top 71 of substrate 58 is configured to receive fluid ejected by pen 30 and to support the ejected ink while an image of the ejected ink is captured by vision systems 64. In the example embodiment illustrated, substrate 58 is formed from a transparent material, such as a transparent polymer or glass, permitting light from light source 62 to pass through substrate 58 to enhance capturing of an image of the ejected ink upon substrate 58 by vision system 64. According to one embodiment, substrate 58 may be formed from glass or silicon dioxide (SiO₂). In other embodiments, substrate 71 may be formed from other transparent materials.

In other embodiments, substrate 58 may have other configurations. For example, in other embodiment where light source 62 is not employed or wherein light source 62 illuminates substrate 58 from a top side of substrate 58, substrate 58, may be formed from one or more opaque materials. For example, in other embodiments, substrate 58 may be formed from one or more sputtered or polished metals such as tantalum or stainless steel. In other embodiments where substrate 58 does not receive fluid ejected from pen 30, but alternatively supports another medium that receives the ejected fluid and that holds ejected fluid while an image of the ejected fluid is captured by vision system 64, substrate 58 may be formed from other materials.

Actuator 60 comprises a mechanism configured to selectively move substrate 58 between the inactive position and one or more active positions. In the particular embodiment illustrated, actuator 60 is configured to raise and lower substrate 58 in the identified Z-axis in a direction perpendicular to top 71 of substrate 58. According to one embodiment, actuator 60 may comprise a motor driving a pinion gear which is in engagement with a rack gear (not shown) associated with substrate 58. In another embodiment, actuator 60 may comprise a motor driving a cam and cam follower arrangement (not shown) configured to move substrate 58. In yet other embodiments, actuator 60 may comprise one or more hydraulic or pneumatic cylinder assemblies or one or more electric solenoids operably coupled to substrate 58 for selectively moving substrate 58. In still other embodiments, actuator 60 may comprise other mechanisms for physically raising and lowering substrate 58. In still other embodiments, in lieu of comprising an electrically powered or battery powered actuator, actuator 60 may comprise a manually powered mechanism, such as a lever, crank of the like configured to permit a person to manually raise and lower substrate 58.

Light source 62 (schematically shown) comprises a source of light configured to direct light through substrate 58. The light provided by light source 62 and directed through substrate 58 and enhances sensing of fluid ejected by nozzles 44 onto substrate 58. In those embodiments where nozzles 44 eject fluid onto another translucent or transparent thin media resting upon and supported by substrate 58, light from light source 62 may additionally pass through the media on top of substrate 58 to enhance sensing or the capture an image of ejected fluid. According to one embodiment, light source 62 may comprise one or more incandescent light bulbs. Another embodiment, light source 62 may comprise light emitting diodes or other presently available or future developed light sources. In other embodiments, light source 62 may be omitted.

Vision system 64 comprises one or more devices configured to sense or otherwise capture any image of fluid ejected by nozzles 44 of pen 30. For purposes of this disclosure, the term “capture” means to generate a digital electronic image. In the example embodiment illustrated, vision system 64 is configured to capture an image of a sufficiently large area of substrate 58 so as to capture an entire array of marks formed by fluid ejected from each one of the nozzles 44 of pen 30. According to one embodiment, vision system 64 includes a telecentric lens. In one embodiment, vision system 64 comprises one or more static cameras. In another embodiment, vision system 64 comprises one or more motion or movie cameras. In other embodiments, vision system 64 may have other configurations. Actuator 65 comprises a mechanism operably connected to vision system 64 and carried by carriage 31 that is configured to move vision system 64 in a direction substantially perpendicular to the direction in which actuator 32 moose carriage 31. Actuator 65 assists in centering vision system 64 with respect to printed marks as Obi described hereafter. In one embodiment, actuator 65 may comprise a voice coil. In other embalmers come actuator 65 may comprise other mechanisms configured for moving vision system 64 relative to carriage 31.

Substrate servicing system 66 comprises a system configured to clean substrate 58. In particular, substrate servicing system 66 is configured to remove fluid or fluid marks from top 71 after an image of the fluid or marks has been captured by vision system 64 and prior to the ejection of new marks upon top 71 of substrate 58. Servicing system 66 includes reservoir 74, applicator 76, wiper 78, gutter 80 and actuator 82.

Reservoir 74 comprises a container or volume of cleaning fluid configured to be applied to top 71 to facilitate removal of ejected fluid from top 71. Reservoir 74 supplies the cleaning fluid to applicator 76. In one embodiment, the cleaning fluid comprises a solvent. In other embodiments, the cleaning fluid may comprise other fluids. In still other embodiments, reservoir 74 may be omitted.

Applicator 76 comprises a device configured to apply the cleaning fluid from reservoir 74 onto top 71 of substrate 58. Applicator 76 receives cleaning fluid from reservoir 74. In one embodiment, applicator 76 may comprise a fabric, sponge or foam compressible roller which receives the cleaning fluid from reservoir 74 via a wick and which is configured to be moved across top 71 of substrate 58. In other embodiments, applicator 76 may alternatively be configured to spray or otherwise dispense cleaning fluid onto top 71 of substrate 58. In still other embodiments, applicator 76 and reservoir 74 may be omitted.

Wiper 78 comprises a structure configured to engage and wipe or scrape ejected fluid (and cleaning fluid) from top 71 so as to clean top 71. In one embodiment, wiper 78 comprises an elastomeric resiliently flexible blade configured to squeegee top 71. In other embodiments, wiper 78 may have other configurations.

Gutter 80 comprises a trough extending along the sides and ends of substrate 58. Gutter 80 receives materials or fluids removed by wiper 78. Although illustrated as being attached to substrate 58 so as to move with substrate 58, in other embodiments, gutter 80 may be stationary position within enclosure 50, wherein substrate 58 extends adjacent to gutter 80 in the inactive position during cleaning by servicing system 66. In other embodiments, gutter 80 may be omitted or other mechanisms, such as when an absorbent wiper or other absorbed roller are used to retain fluids removed from top 71.

Actuator 82 comprises a mechanism configured to move applicator 76 and wiper 78 with respect to top 71 of substrate 58. In the particular example illustrated, actuator 82 is configured to move applicator 76 and wiper 78 in the illustrated X-axis direction parallel to top 71 as indicated by arrows 84 and in the illustrated Z-axis direction perpendicular to top 71 as indicated by arrows 86. As a result, actuator 82 is configured to move applicator 76 and wiper 78 along the X-axis direction across top 71 to wipe top 71 while substrate 58 is substantially stationary in the X-axis direction. In addition, actuator 82 may raise or lower applicator 76 and wiper 78 towards and away from top 71 to vary a pressure applied by applicator 76 or wiper 78 to top 71 during servicing.

According one embodiment, actuator 82 may comprise one or more hydraulic or pneumatic cylinder assemblies, one or more electric solenoids or one or more motor driven linear actuators such as belt and pulley arrangements, chain and sprocket arrangements, rack and pinion gear arrangements or cam and cam follower arrangements. In some embodiments, actuator 82 may alternatively be configured to move applicator 76 and wiper 78 in the direction indicated by arrows 84, wherein actuator 60 is employed to move substrate 58 in the Z-axis direction to vary and control inter-engagement forces or pressures between top 71 and applicator 76 or wiper 78. In yet other embodiments, actuator 82 may be omitted where servicing system 66 is omitted or where substrate 58 is moved relative to applicator 76 or wiper 78.

Interface 38 comprises one or more devices configured to facilitate entry of commands or instructions to controller 40. In one embodiment, interface 38 is configured to facilitate entry of commands or instructions from user of printer 20. For example, interface 38 may comprise a mouse, touchpad, touch screen, keyboard, button, switch, camera or microphone with appropriate voice or speech recognition software. In another embodiment, interface 38 may be configured to facilitate receipt of control signals from an external electronic device. For example, interface 38 may comprise a port by which a cable may be connected to printer 20 for transmission of control signals to controller 40. Interface 38 facilitates entry of commands instructing controller 40 to determine the quantity or other characteristics of ejected fluid by pen 30 and to make appropriate adjustments at selected times or intervals or based upon selected usage thresholds of printer 20.

Interface 38 further facilitate entry of information related to characteristics of the fluid being ejected, such as a type of fluid or chemical properties of the fluid, wherein controller 40 may make different ejection parameter adjustments based upon information from sensing system 36 depending upon the type or characteristic of fluid to be ejected. For example, controller 40 may generate a first set of control signals to eject a first quantity of a first fluid with a nozzle or grouping of nozzles based on information received from sensing system 36 and may generate a second distinct set of control signals to eject the same first quantity of a second chemically distinct fluid with the same nozzle or grouping of nozzles based upon information received from sensing system 36, when controller receives an indication via interface 38 that the second fluid is to be ejected. In particular embodiments, controller 40 may be configured to automatically sense actual ejection characteristics in response to receiving information that a different type of fluid is being ejected.

Sensor 39 comprises one or more sensing devices configured to sense one or more factors which may have an impact upon ejection characteristics of pen 30. In one embodiment, sensor 39 may comprise one or more sensing device configured to sense environmental conditions such as temperature or humidity. Sensor 39 is further configured transmit such information to controller 40. Based upon such information, controller 40 may make different ejection parameter adjustments based upon information from sensor 39 and based upon information from sensing system 36. In particular embodiments, controller 40 may be configured to automatically initiate a sensing of actual ejection characteristics in response to receiving information indicating a change in environmental conditions. In other embodiments, sensor 39 may be omitted.

Controller 40 comprises one or more processing units configured to generate control signals directing the operation of transport 26, pen 30, actuator 32, service station 34 and sensing system 36. Controller 40 is further configured to receive and analyze signals from sensing system 36, interface 38 and sensor 39. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, controller 40 may be embodied as part of one or more application-specific integrated circuits (ASICs). Unless otherwise specifically noted, the controller is not limited to any specific combination of hardware circuitry and software, nor to any particular source for the instructions executed by the processing unit.

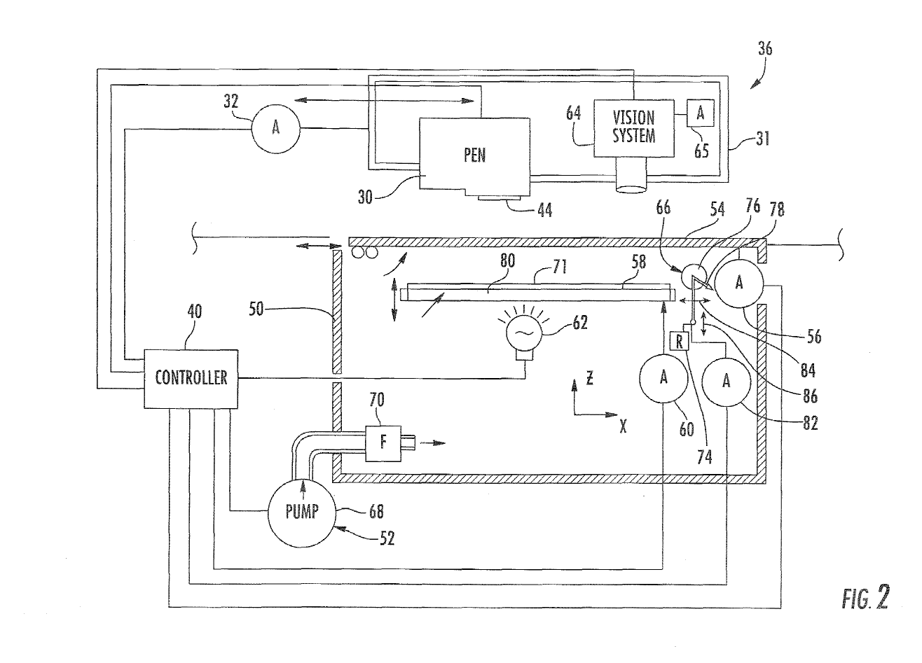

FIG. 3 is a flow diagram illustrating an example method 100 by which printer 20 may operate under direction of control signals from controller 40. In the example shown in FIG. 3, method 100 is a closed loop arrangement of steps providing printer 20 with closed loop feedback regarding ejection characteristics of the fluid being ejected, facilitating closed-loop calibration or adjustment. As a result, operation of printer 20 may be adjusted to maintain performance levels over the life of printer 20 despite temporal shifts and variations in printing performance experienced by printer 20.

As indicated by step 110, controller 40 generates control signals directing actuator 32 to position nozzles 44 of pen 30 (shown in FIGS. 1 and 2) opposite to transport 26 as shown in FIG. 1 such that pen 30 is generally opposite to target media being carried by transport 26. Thereafter, controller 40 generates control signals directing one or more nozzles 44 of pen 30 to eject fluid onto the target media using existing ejection parameters. The ejection parameters may include the timing in which such nozzles are fired and carriage velocity and position when fired (to set nozzle/target relative position at time of firing, and control droplet trajectory between time of firing and impact) as well as the firing energy to be used to eject fluid from one or more nozzles. As noted above, the fire energy may include at least one aspect of firing intensity, such as number of pulses applied to a given nozzle, pulse voltage, pulse time, pulse frequency, and the number of nozzles that are pulsed, and the temperature of the nozzle array (which may be controlled by resistors on the printhead). Controller 40 generates control signals such that the target media is coated in a pattern or image with one or more fluids. As noted above, the target media may be two-dimensional or three-dimensional.

As indicated by step 130, controller 40 makes a determination as to whether actual ejection characteristics, such as ejection location or quantity, should be sensed (and potentially recalibrated) using sensing system 36. In one embodiment, controller 40, following instructions contained within a memory in the form of software or computer readable program, or per architecture of an ASIC, may be configured to automatically initiate sensing of ejection characteristics using sensing system 36 at predetermined times. For example, a user of printer 20 may instruct controller 40, through interface 38, to perform such ejection characteristic sensing or testing every Saturday at 1 p.m. or once every three days. In another embodiment, controller 40 may be configured to perform such ejection characteristic sensing or testing after an amount of fluid ejected by a particular nozzle, a particular group of nozzles or the entire pen 30 has exceeded a predetermined threshold entered via interface 39 or programmed into printer 20 during construction of printer 20. In yet other embodiments, controller 40 may be configured to automatically initiate ejection characteristic sensing in response to instructions received via interface 38 directing immediate testing, in response to signals received from interface 38 or another sensor indicating that the type of fluid being ejected has changed or in response to signals from sensor 39 indicating a change in environmental conditions.

As indicated by arrow 132, if the sensing of ejection characteristics is not to occur, step 130 is repeated to continue to print or coat the one or more fluids upon the one or more target media. As indicated by arrow 134 and by step 140, if controller 40 determines that the ejection characteristics are to be tested, controller 40 generates control signals to position sensing system 36 and nozzles 44 of pen 30 opposite to one another. In the particular example illustrated in FIG. 1, controller 40 generates control signals directing actuator 32 to move pen 30 to a position opposite to sensing system 36 as seen in FIG. 2. In particular embodiments, controller 40 may additionally generate control signals causing actuator 32 to also position pen 30 opposite to service station 34 for servicing while the printing of fluids is already being interrupted. By servicing pen 30 at service station 34 prior to performing ejection characteristic testing or sensing, printer 20 reduces the likelihood of aberrational results resulting from temporary and removable buildup of residue on or adjacent to nozzles 44. In other embodiments, servicing of pen 30 may be performed other times.

In addition to generating control signals directing actuator 32 to appropriately position carriage 31 such that pen 30 and nozzles 44 over sensing system 36, controller 40 additionally generates control signals directing actuator 56 to move cover 54 to the retracted position and directs actuator 60 to raise substrate 58 from the lowered inactive position to the raised active position. In one embodiment, controller 40 may generate control signals such that actuator 60 elevates substrate 58 to position top 71 at a spacing from nozzles 44 substantially corresponding to the spacing of a surface to be subsequently coated upon. In one embodiment, this spacing information may be communicated to controller 40 the interface 38. In yet another embodiment, this spacing may be sensed with a sensor during earlier printing upon a similar target media.

In addition, controller 40 may generate control signals actuating light source 62. Alternatively, light source 62 may be maintained in a powered ready state during use of printer 20.

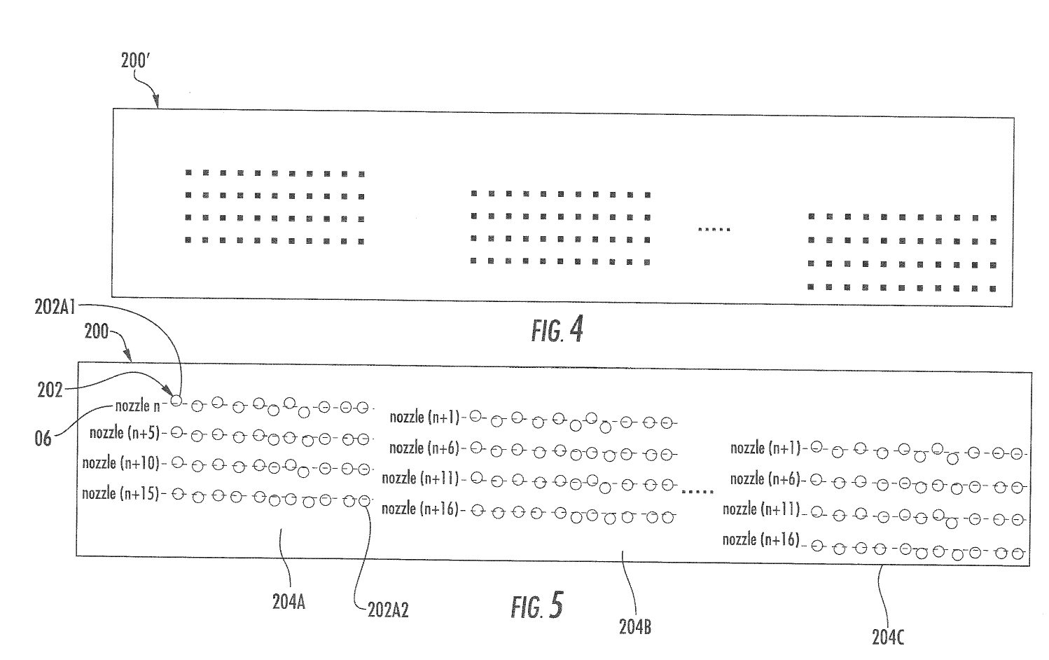

As indicated by step 150, once nozzles 44 and substrate 58 have been a appropriately positioned with respect to one another, controller 40 generates control signals directing nozzles 44 to eject fluid onto substrate 58 (or onto another media supported by substrate 58). In particular, controller 40 directs pen 30 to print an array of fluid diagnostic spots or marks using a selected grouping of nozzles 44 or substantially all of nozzles 44. FIG. 4 schematically illustrates an example hypothetical pattern 200′ printed by a portion of nozzles 44 of pen 30 where nozzles 44 of pen 30 have no directionality or trajectory errors. FIG. 6 schematically illustrates the same example pattern 200 of actual marks 202 printed by the same portion of nozzles 44, wherein the nozzles have directionality or trajection errors. Such trajection errors may be the result of variations in firing chamber geometry, the presence of bubbles in the pen 30, the presence of puddles on a face of nozzles 44, changes in properties of the fluid being ejected (as with temperature), the frequency at which fluid is ejected or “jetted” from particular nozzles and other factors. Such variation reduces print quality.

In the example illustrated, pattern 200 comprises multiple arrays 204A, 204B and 204C (collectively referred to as arrays 204), each array 204 including multiple spaced rows 206 having a predetermined number of marks 202 printed by every fifth nozzle 44. Adjacent nozzles are not printed together because the resultant spots would overlap, inhibiting the collection of individual spot/nozzle positional information. In the example illustrated, each row includes 11 Mark 202. The printing of arrays 204 continues until a row 206 of marks 202 has been printed by each nozzle 44 of pen 30. In other embodiments, controller 40 may generate control signals directing print head 30 to print other patterns having one or more arrays having different number of marks per row, different numbers of rows and different spacings.

As indicated by step 160, once the one or more arrays 204 of marks 202 has been printed, controller 40 selects at least two marks 202 for serving as anchor marks for each array 204 or for a grouping of arrays 204. In particular, controller 40 generates control signals directing actuator 32 to move carriage 31 so as to position vision system 64 directly overhead one of marks 202 selected as a first anchor mark and recording a position of the first anchor mark based upon the positioning of carriage 31, vision system 64, pen 30 and the like as determined by a positioning system associated with carriage 31 or components carried by carriage 31. For example, in one embodiment, the positioning of vision system 64 and pen 30 may be tracked by an encoder associated with actuator 32. The first anchor mark 202 is assigned coordinates based upon values from the encoder when vision system 64 directly overlies the first anchor mark. For example, in one embodiment, the first anchor mark 202A1 may comprise a first mark 202 in a first row of an array such as shown in FIG. 6. FIG. 6 schematically illustrates vision system 64 position directly over a first anchor mark 202A1. Such positioning of the sensor over a single individual mark, for the purpose of anchor-mark locational measurement, may also be done by semi-manually moving the sensor exactly over the top of the mark,with the aid of high magnification optics.

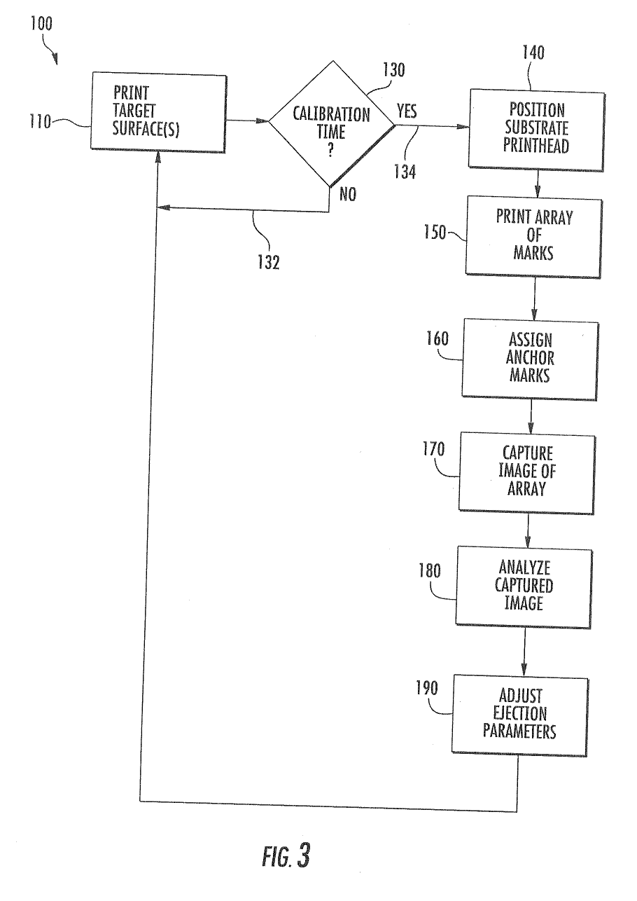

Once the first anchor mark has been assigned, controller 40 generates control signals directing actuator 32 to move carriage 31 such that vision system 64 is position directly overhead a second one of marks 202 selected to serve as a second anchor mark. This mark is created by a different nozzle, such as a nozzle that is at the other end of the array of nozzles, to provide enhanced detection of and hence compensation for angular misalignment. Thus, the second anchor point has X and Y axis coordinates different from the first anchor point. As with the first anchor mark, the positioning of the selected second anchor mark 202 is assigned coordinates based upon values from a positioning system associate with carriage 31 or associate carried by carriage 31. For example, in one embodiment, the accordance assigned to the second anchor mark 202 may be provided by an encoder associate with actuator 32. According to one embodiment, a second anchor mark 202A2 may comprise a last mark 202 in a last row of an array such as shown in FIG. 5. FIG. 6 also illustrates the second anchor mark 202A2. According to one embodiment, the sensor/vision system 64 has a field of view of the target, within which an electronic cross-hair may be set in a fixed position on a monitoring screen (not shown). This e-crosshair is used to locate the anchor points. First,: the carriage and sensor attached to it (and hence the e-crosshair, as viewed through the monitor) are moved over the first anchor mark and the vision system 64 is zoomed (set to a higher magnification) in to find the center of this first anchor mark. Once the center of the first anchor mark is found, the coordinates of carriage 31 and that of actuator relative to a datum are measured and recorded. The same process is used to locate the center of a second anchor mark using the e-cross-hair and magnification. Once again, the coordinates of carriage 31 and that of actuator relative to a datum when system 64 is centered over the second anchor mark are measured and recorded. Using the measured coordinates, controller 40 calculates an actual physical distance per pixel of the bitmap captured by system 64. In other words, controller 40 calibrates or does a conversion between pixels in the bitmap and the number of microns that these pixels correspond to in actual x,y space; and in the case of spot area, translate square pixels into square microns. This calibration is used to determine location and spot size variations from nozzle to nozzle.

Although the assignment of selected marks 202 as anchor marks has been described as being performed after each of the arrays 204 of marks 202 have been printed, in other embodiments, the assignment or selection of anchor marks may be made during printing by interrupting the printing and appropriately positioning vision system 64 over a selected mark 202. Although FIG. 6 illustrates two corner most marks 202 selected as serving as the anchor marks, in other embodiments, other marks 202 may be selected as the anchor marks.

As indicated by step 170, upon assignment of anchor marks, vision system 64 captures one or more images of one or more of the arrays 204. Each image includes substantially all of the marks 202 of at least one array 204. In one embodiment, controller 40 may generate control signals adjusting a focus of vision system 64 by modifying or adjusting the positioning of a lens. In one embodiment, vision system 64 includes a telecentric lens. The electronic image representing the captured image of the one or more arrays 204, including the anchor marks 202, are transmitted to controller 40 for analysis.

As indicated by step 180, controller 40 analyzes the captured image(s). According to one embodiment, controller 40 identifies trajectories or directionalities of each of nozzles 44. In particular, controller 40, using the captured image, determines distances separating each mark 202 from the anchor marks 202A1 and 202A2. Using the predetermined coordinates of the assigned anchor marks 202A1 in 202A2, controller 40 may then determine coordinates for each of the remaining marks 202 by applying the appropriate scaling and angular rotation as appropriate. By comparing the actual coordinates of marks 202 with the intended or expected coordinates of marks 202 for each nozzle 44, controller 40 may determine adjustments or corrections to ejection parameters such that subsequent printing by each nozzle 44 result in fluid being deposited in closer proximity to the desired or intended locations upon a surface. For example, controller 40 may adjust the ejection parameters stored in its memory for a particular nozzle 44 such that a particular nozzle 44 is fired sooner or later in time during printing or during scanning of pen 30 to at least partially correct for any locational errors resulting from directionality variations or errors of the particular nozzle 44. As indicated by step 190, controller 40 may calculate and store and adjusted the ejection control parameters (such as the effective nozzle map) for the particular group of nozzles 44 for future use in controlling the printing by such nozzles 44.

According to one embodiment, controller 40 may additionally or alternatively analyze the captured image to determine or estimate a drop volume or fluid quantity ejected from each nozzle 44. In particular, controller 40 may determine or measure a diameter or size of one or more of marks 202. Using a stored look-up table containing correlating mark size to drop volume particular fluid at a particular spacing between nozzles 44 and substrate 58 or by applying one or more stored algorithms to the determined mark size, controller 40 may determine the quantity of fluid (and hence solute flux) ejected by each nozzle 44 for a given number of drops ejected or deposited at a particular location. Upon determining the quantity of fluid contained in each drop to or quantity of drops ejected by each nozzle 44, controller 40 may either discontinue use or particular nozzle if the particular nozzle is ejecting a quantity of fluid less than a predetermined minimum threshold or may adjust ejection parameters (e.g. number of drop jetted from a given nozzle per pass, or number of passes that nozzle makes over the target) stored in its memory (as indicated by step 190) such that the firing energy applied to the particular nozzle 44 for a particular quantity of fluid is adjusted. As a result, the difference between the actual quantity of fluid ejected by nozzle in the intended quantity of fluid to be ejected by nozzle may be reduced or eliminated.

As described above, sensing system 36 facilitates adjustments to at least partially correct for directionality and drop volume variations or errors of individual nozzles 44. Such errors may be partially dependent upon the spacing between nozzles 44 and the target surface being printed upon. For example, printing location errors may be enlarged as the spacing between the nozzles 44 and the surface being printed upon is increased. Likewise, the amount of fluid actually reaching and being coated upon a target surface may vary depending upon the spacing between the target surface and nozzles 44. In one embodiment, the spacing between the chart service and nozzles 44 is accordingly minimized.

FIGS. 7-10 illustrate use of sensing system 36 to adjust printing control for different spacings between nozzles 44 and different target surfaces. FIG. 7 schematically illustrates carriage 31 moved by actuator 32 to position pen 30 opposite to top 71 of a substrate 58 with cover 54 (shown in FIG. 2) retracted. FIG. 7 further illustrates top 71 of substrate 50 moved by actuator 60 to a vertical height such that top 71 is spaced from nozzles 44 of pen 30 by a spacing S1. The spacing S1 is substantially the same as and corresponds to an expected spacing between nozzles 44 and a first target surface to be subsequently coated with fluid from nozzles 44.

Spacing S1 may be provided to controller 40 via interface 38 (shown in FIG. 2) or may be provided to controller 40 (shown in FIG. 1) by another sensor during printing of a previously printed upon target surface (such as when a series of similar target surfaces are to be coated). In yet other embodiments, spacing S1 may be one of many spacings in a range of spacings to be tested, wherein the results of such testing at the various spacings is stored in a database for subsequently coating or printing upon different surfaces having different sensed spacings from nozzles 44.

As schematically illustrated by FIG. 7, controller 40 (shown in FIG. 1) generates control signals directing print head 32 print an array 204 of marks 202 onto top 71 of a substrate 58 (or in other relatively thin testing media supported by substrate 58) as described above with respect to step 150 of FIG. 3. Thereafter, controller 100 continues with the calibration process by performing steps 160-190 illustrated and described above with respect to method 100 in FIG. 3. In the particular example illustrated, controller 40 stores in memory any adjustments used to deposit a desired quantity of fluid upon a surface by each nozzle 44 when the surface is spaced from nozzles 44 by spacing S1. Controller 40 further stores in memory any adjustment used to reduce or eliminate differences between the intended or desired coating location and the actual coating location by each nozzle 44 when the surface being coated upon is spaced from nozzles 44 by spacing S1.

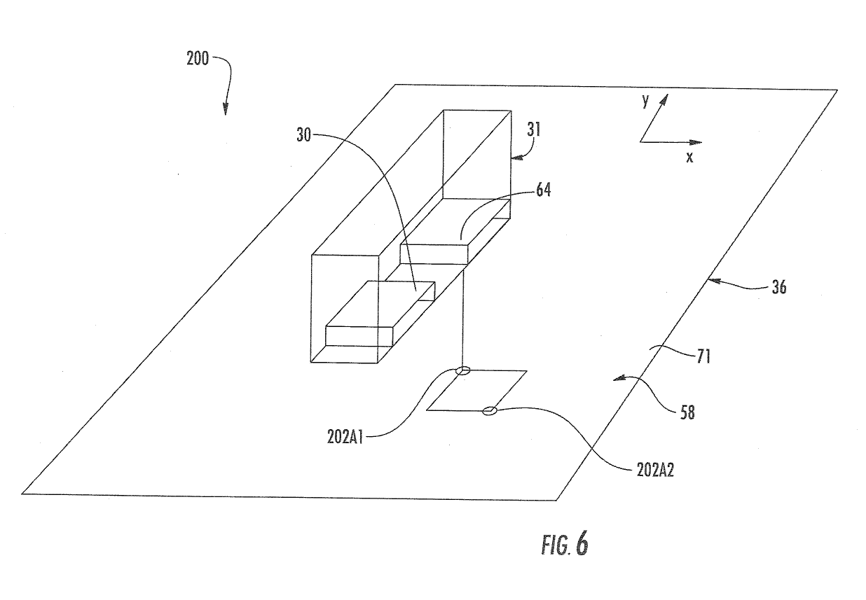

As shown by FIG. 8, controller 40 repeats this process again, but with top 71 of substrate 58 moved by actuator 60 from the previous position 301 to a different position 302, wherein top 71 is spaced from nozzles 44 of pen 30 by a different spacing S2. The spacing S2 is substantially the same as and corresponds to an expected spacing between nozzles 44 and a second target surface to be subsequently coated with fluid from nozzles 44.

As with spacing S1, spacing S2 may be provided to controller 40 via interface 38 (shown in FIG. 2) or may be provided to controller 40 (shown in FIG. 1) by another sensor during printing of a previously printed upon target surface (such as when a series of similar target surfaces are to be coated). In yet other embodiments, spacing S2 may be one of many spacings in a range of spacings to be tested, wherein the results of such testing at the various spacings is stored in a database for subsequently coating or printing upon different surfaces having different sensed spacings from nozzles 44.

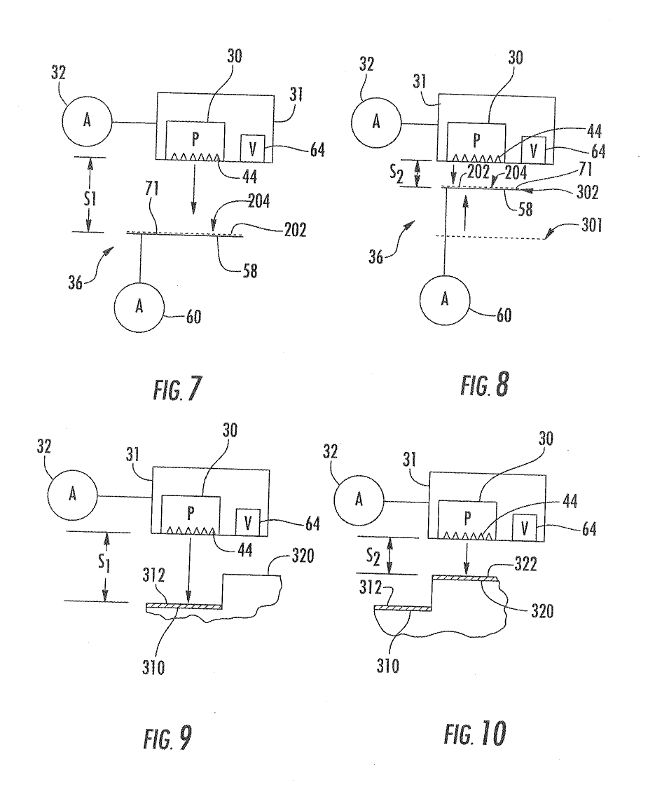

FIGS. 9 and 10 schematically illustrate subsequent printing or coating of fluids upon the first and second target surfaces using different stored calibration adjustments, such as those provided by a sensing system 36 during the processes described above with respect to FIGS. 7 and 8. In particular, FIG. 9 illustrates nozzles 44 of pen 30 ejecting fluid onto target surface 310 to form a pattern coming image or other coating or 312 upon surface 310. As shown by FIG. 9, surface 310 is spaced from nozzles 44 by the previous tested spacing S1. During such printing, controller 40 utilizes the previously determined calibration adjustments stored for subsequent use when printing upon a surface spaced from nozzles 44 by spacing S1. As a result, coating 312 is more accurately and precisely printed upon surface 310 in the intended quantities and locations.

FIG. 10 illustrates nozzles 44 of pen 30 ejecting fluid onto target surface 320 to form a pattern, image or other coating 322 upon surface 320. As shown by FIG. 10, surface 320 is spaced from nozzles 44 by the previous tested spacing S2. During such printing, controller 40 utilizes the previously determined calibration adjustments stored for subsequent use when printing upon a surface spaced from nozzles 44 by spacing S2. As a result, coating 322 is more accurately and precisely printed upon surface 320 in the intended quantities and locations.

Although printing upon surfaces 310 and 320 has been described as being performed after determining and storing appropriate adjustments at both spacings S1 and S2, in other embodiments, printing upon surface 310 using stored adjustments for spacing S1 may be performed prior to determining and storing adjustments for spacing S2. Although surfaces 310 and 320 are illustrated as comprising surfaces of a single target media or target object, in other instances, surfaces 310 and 320 may be surfaces of different independent mediums or objects. Although each of surfaces 310 and 320 is illustrated as being substantially horizontal, generally parallel to a plane which nozzles 44 extend and is being stepped with respect to one another, in other embodiments, surfaces 310 and 320 may be oblique with respect to the plane of nozzles 44. For example, in one embodiment, surfaces 310 and 320 may comprise distinct points or elevations along a curve or ramp. In such an embodiment, when printing fluid upon a point or location intermediate such surfaces 310 and 320, controller 40 may utilize ejection control parameters (such as firing energy and firing timing) which are interpolations of the adjusted ejection control parameters for spacings S1 and S2.

Overall, because printer 20 adjusts for directionality and drop volume variations over time while taking into account such variations at different spacings, printer 20 provides enhanced control over the quantity of fluid ejected by each nozzle 44 onto a surface and control over the location at which fluid is deposited upon the target. As a result, printer 20 may provide enhanced printing control when printing coatings upon medical devices, when printing medicinal drugs or chemicals upon testing strips or other objects or when printing fluid to form semi conductor or MEMs structures upon a surface.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a print head;
a vision system;
a carriage carrying a print head;
a horizontal substrate;
an actuator configured to vertically move the substrate with respect to the carriage; and
a controller configured to generate control signals, wherein the actuator moves the substrate to desired spacing from the print head, wherein the print head prints an array of marks on the substrate and wherein the vision system captures at least one 11 image of the array of marks on the substrate in response to the control signals and wherein the controller controls subsequent printing by the print head based upon the at least one captured image.

2. The system of claim 1, wherein the substrate is substantially transparent and wherein the system further comprises a light source on an opposite side of the substrate as the vision system.

3. The system of claim 2, wherein the vision system is carried by the carriage.

4. The system of claim 1 further comprising a cover between the substrate and the carriage, wherein the cover is movable between a covering position and a retracted position.

5. The system of claim further comprising a wiper configured to wipe the array of marks from the substrate.

6. The system of claim 1, wherein the controller is configured to determine a volume of fluid deposited by nozzles of the print head based upon the at least one captured image.

7. The system of claim 1, wherein the array of marks includes at least one mark from each nozzle of the print head and wherein the vision system is configured to capture an image of an entirety of the array.

8. The system of claim 1 further comprising a source of ionized gas configured to supply ionized gas to at least one of the carriage and the substrate.

9. The system of claim 1, wherein the substrate is selected from a group of materials consisting of: glass, SiO₂, sputtered metals and polished metals.

10. The system of claim 1, wherein the substrate comprises a plate or wafer.

11. A method comprising:
moving a substrate in a direction perpendicular to and towards a print head to a first position opposite a print head;
printing with the print head a first array of marks on the substrate while the substrate is at the first position;
capturing a first image of the first array of marks; and
controlling subsequent printing using the print head based upon the captured first image.

12. The method of claim 11 further comprising locating a vision system over at least two of the marks while assigning coordinates to the at least two marks, wherein subsequent printing is controlled using the assigned coordinates with the captured first image.

13. The method of claim 11 further comprising:
determining a size of one of the marks;
determining a volume of fluid ejected by a nozzle that formed said one of the marks; and
ejecting fluid with the nozzle based on the determine volume.

14. The method of claim 11 further comprising wiping the substrate.

15. The method of claim 11 further comprising directing light through the substrate towards the vision system while the first image is captured.

16. The method of claim 11 further comprising:
moving the substrate in the direction perpendicular to and towards the print head to a second position opposite a print head;
printing with the print head a second array of marks on the substrate while the substrate is at the second position;
capturing a second image of the second array of marks; and
controlling subsequent printing using the print head based upon the the captured second image.

17. The method of claim 11, wherein the substrate comprises a plate.

18. The method of claim 11, wherein the first image captured is that of substantially all nozzles of the print head.

19. A method comprising:
positioning at least one substrate at a plurality of spacings with respect to a print head, each spacing corresponding to spacing of a target surface to be subsequently printed upon with respect to the print head;
printing arrays of marks, each array printed upon the least one substrate while the least one substrate is at a different one of the spacings;
capturing images of the arrays of marks; and
printing upon target surfaces spaced from the print head by the spacings based upon the captured images.

20. The method of claim 19 further comprising:
determining a size of one of the marks;
determining a volume of solute ejected by a nozzle that formed said one of the marks; and
ejecting fluid with the nozzle based on the determined volume
